(19) United States
(12) Patent Application Publication
(10) Pub. No.: US 2013/0135508 A1
(43) Pub. Date: May 30, 2013

(54) PERSONAL IMAGE DATA ACQUISITION APPARATUS AND PERSONAL IMAGE DATA ACQUISITION METHOD

(71) Applicant: Katsuharu INABA, Honjo-shi (JP)

(72) Inventor: Katsuharu INABA, Honjo-shi (JP)

(73) Assignee: KABUSHIKI KAISHA TOSHIBA, Tokyo (JP)

(21) Appl. No.: 13/587,683

(22) Filed: Aug. 16, 2012

(30) Foreign Application Priority Data
Nov. 30, 2011 (JP) 2011-262518

(51) Int. Cl. H04N 5/222

(52) U.S. Cl. 348/333.01; 348/E05.022

(57) ABSTRACT

According to one embodiment, a personal image data acquisition apparatus includes a display controller, a display, an acquisition module. The display controller is configured to control display based on a plurality of display control settings. The display is configured to change to a plurality of display states based on the display control. The acquisition module is configured to acquire a plurality of personal image data in correspondence with the plurality of display states.

### CROSS-REFERENCE TO RELATED APPLICATIONS

This application is based upon and claims the benefit of priority from prior Japanese Patent Application No. 2011-262518, filed Nov. 30, 2011, the entire contents of which are incorporated herein by reference.

### FIELD

Embodiments described herein relate generally to a personal image data acquisition apparatus and personal image data acquisition method.

### BACKGROUND

In recent years, a digital TV which includes a camera has been proposed. The digital TV recognizes a user who is about to use (view) the digital TV using face image data captured by the camera, and can provide user-dependent services and the like.

For example, the digital TV registers personal information (including age) and face image data in association with each other. The digital TV captures an image of a user who is about to use (view) the digital TV, and compares the registered face image data (face image feature data) with the captured face image data (face image feature data) to recognize the user, thereby discriminating an age based on the user recognition result. The digital TV can control playback of age-restricted content using the age discrimination result of the user.

However, capturing conditions in a registration mode rarely perfectly match those in a recognition mode. For example, the positional relationship between the user (face) and illumination, illuminance, and an orientation and position of the user (face) with respect to the camera are different in the registration and recognition modes. For this reason, shadows making states and light reflected states on the face of the user are different in the registration and recognition modes. For this reason, even as face image data captured from a single person, face image data captured in the registration mode rarely perfectly matches that captured in the recognition mode. A technique which compares face image data captured in the registration mode and that captured in the recognition mode, which data do not perfectly match, as described above, and determines whether or not they are face image data of an identical person has been proposed.

Although the aforementioned technique has been proposed, since face image data captured in the registration mode does not perfectly match that captured in the recognition mode, recognition precision often drops, and an improvement measure against such recognition precision drop is demanded.

The recognition precision drop can be eliminated if the same capturing conditions are set in the registration and recognition modes. However, a heavy load is imposed on the user to set the same capturing conditions in the registration and recognition modes.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing an example of the arrangement of a personal image data acquisition apparatus according to respective embodiments of the present invention;

FIG. 2A is a side view showing an example of the positional relationship between a display device and image sensor included in the personal image data acquisition apparatus, and a registration user;

FIG. 2B is a top view showing an example of the positional relationship between the display device and image sensor included in the personal image data acquisition apparatus, and the registration user;

FIG. 3 is a view showing examples of a plurality of display states, and examples of shadow making states in correspondence with the plurality of display states according to the first embodiment;

FIG. 4 is a view showing examples of a plurality of display states according to the second embodiment;

FIG. 5A is a view showing an example of the positional relationship between the display device (image sensor) and registration user in the registration mode according to the fourth embodiment;

FIG. 5B is a view showing an example of the positional relationship between the display device (image sensor) and registration user in the recognition mode according to the fourth embodiment;

FIG. 6A is a view showing an example of the positional relationship between the display device (image sensor) and registration user in the registration mode according to the fifth embodiment;

FIG. 6B is a view showing guide display examples in the registration mode according to the fifth embodiment;

FIG. 7A is a view showing a layout example of the image sensor in the registration mode according to the sixth embodiment;

FIG. 7B is a view showing an example of the arrangement of the image sensor according to the sixth embodiment; and

FIG. 8 is a schematic block diagram showing an example of the arrangement of a digital television broadcast receiver to which the personal image data acquisition apparatus is applied.

### DETAILED DESCRIPTION

Various embodiments will be described hereinafter with reference to the accompanying drawings.

In general, according to one embodiment, a personal image data acquisition apparatus includes a display controller, a display, and an acquisition module. The display controller is configured to control display based on a plurality of display control settings. The display is configured to change to a plurality of display states based on the display control. The acquisition module is configured to acquire a plurality of personal image data in correspondence with the plurality of display states.

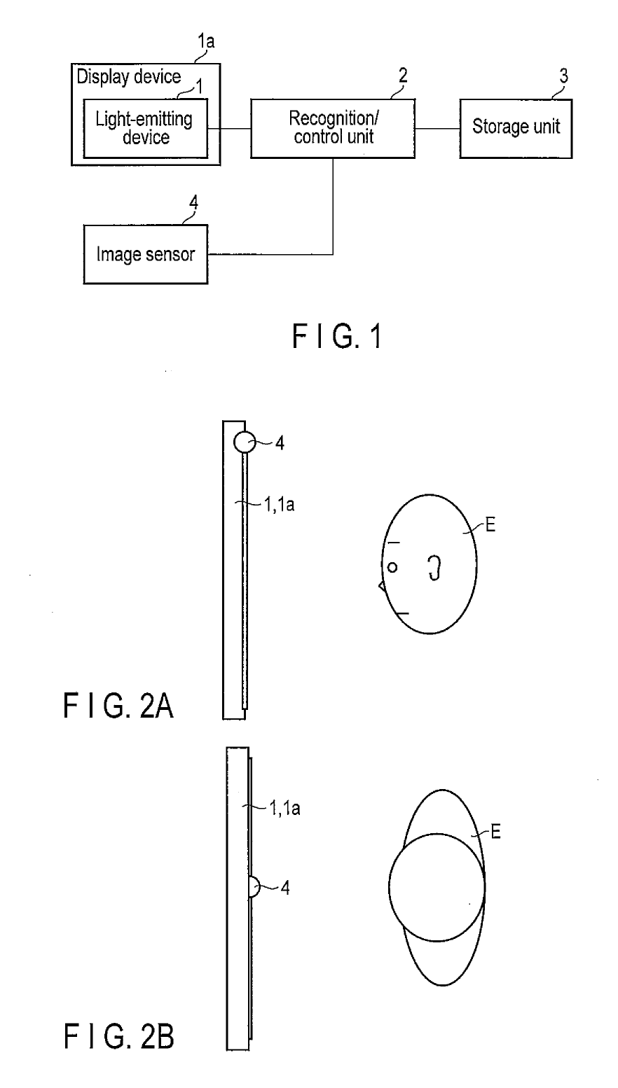

FIG. 1 is a schematic block diagram showing an example of the arrangement of a personal image data acquisition apparatus according to respective embodiments of the present invention. FIG. 2A is a side view showing an example of the positional relationship between a display device and image sensor included in the personal image data acquisition apparatus, and a registration user. FIG. 2B is a top view showing an example of the positional relationship between the display device and image sensor included in the personal image data acquisition apparatus, and the registration user.

As shown in FIG. 1, the personal image data acquisition apparatus includes a display device 1, recognition/control unit 2, storage unit 3, and image sensor 4. The display device 1 includes a light-emitting device (backlight) la. The recognition/control unit 2 controls display of the display device 1 based on a plurality of display control settings stored in the storage unit 3. The display device 1 changes to a plurality of display states based on the display control. The display control will be described in detail later.

The image sensor 4 is, for example, a camera. In response to execution of a registration mode, the recognition/control unit 2 extracts face image data of a person (registration target user E) from an image captured by the image sensor 4, and registers the extracted face image data in the storage unit 3. Alternatively, in response to execution of the registration mode, the recognition/control unit 2 extracts face image data of a person from an image captured by the image sensor 4, extracts face image feature data from the extracted feature image data, and registers the extracted face image feature data in the storage unit 3.

Furthermore, in response to execution of a recognition mode, the recognition/control unit 2 extracts face image data of a person (recognition target user) from an image captured by the image sensor 4, compares the extracted face image data with that registered in the storage unit 3, and recognizes the person based on a matching determination result of the two face image data. Alternatively, in response to execution of the recognition mode, the recognition/control unit 2 extracts face image data of a person from an image captured by the image sensor 4, extracts face image feature data from the extracted face image data, compares the extracted face image feature data with that registered in the storage unit 3, and recognizes the person based on a matching determination result between the two face image feature data.

The first to sixth embodiments will be described hereinafter with reference to the drawings.

### First Embodiment

In response to execution of the registration mode, the recognition/control unit 2 controls display based on a plurality of display control settings stored in the storage unit 3. The display device 1 changes to a plurality of display states based on the display control.

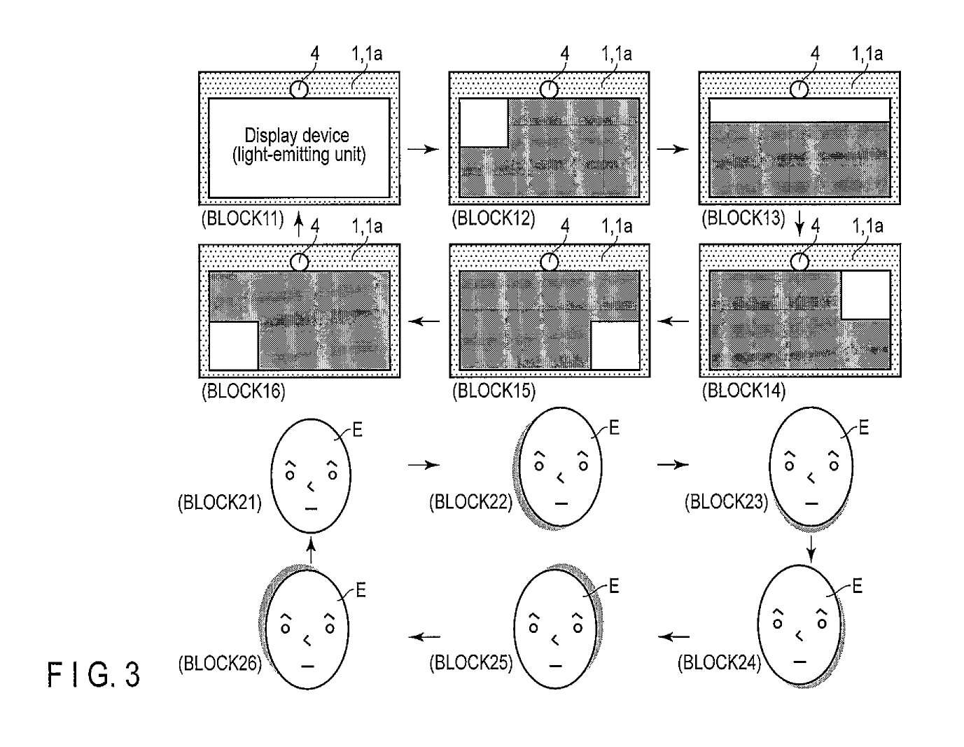

For example, the recognition/control unit 2 controls a display area of the display device 1 based on a plurality of display area control settings stored in the storage unit 3. The display device 1 changes to a plurality of display states based on the display area control ([BLOCK 11] to [BLOCK 16] in FIG. 3).

In other words, the recognition/control unit 2 controls a light-emitting area of the light-emitting device 1a based on a plurality of display area control settings stored in the storage unit 3. The light-emitting device 1a changes to a plurality of light-emitting states based on the light-emitting area control, and the display device 1 changes to the plurality of display states in correspondence with the changes of the light-emitting states ([BLOCK 11] to [BLOCK 16] in FIG. 3).

Since irradiated states of light with a person (registration target user E) at an opposing position of the display device 1 change in correspondence with the changes of the plurality of display states ([BLOCK 11] to [BLOCK 16] in FIG. 3), shadow making states and light reflected states on the person (face) change ([BLOCK 21] to [BLOCK 26] in FIG. 3).

The image sensor 4 acquires a plurality of face image data (personal image data) in correspondence with the plurality of display states. That is, the image sensor 4 captures an image of a person (registration target user E) at the opposing position of the display device 1 in correspondence with a display state of BLOCK 11 in FIG. 3 (=face of BLOCK 21 in FIG. 3) to acquire image data. Furthermore, the recognition/control unit 2 extracts face image data from the acquired image data, and further extracts face image feature data from the face image data.

Likewise, the image sensor 4 captures an image of the person (registration target user E) at the opposing position of the display device 1 in correspondence with a display state of BLOCK 12 in FIG. 3 (=face of BLOCK 22 in FIG. 3) to acquire image data. Furthermore, the recognition/control unit 2 extracts face image data from the acquired image data, and extracts face image feature data from the face image data. The image sensor 4 captures an image of the person (registration target user E) at the opposing position of the display device 1 in correspondence with a display state of BLOCK 13 in FIG. 3 (=face of BLOCK 23 in FIG. 3) to acquire image data. Furthermore, the recognition/control unit 2 extracts face image data from the acquired image data, and extracts face image feature data from the face image data. The image sensor 4 captures an image of the person (registration target user E) at the opposing position of the display device 1 in correspondence with a display state of BLOCK 14 in FIG. 3 (=face of BLOCK 24 in FIG. 3) to acquire image data. Furthermore, the recognition/control unit 2 extracts face image data from the acquired image data, and extracts face image feature data from the face image data. The image sensor 4 captures an image of the person (registration target user E) at the opposing position of the display device 1 in correspondence with a display state of BLOCK 15 in FIG. 3 (=face of BLOCK 25 in FIG. 3) to acquire image data. Furthermore, the recognition/control unit 2 extracts face image data from the acquired image data, and extracts face image feature data from the face image data. The image sensor 4 captures an image of the person (registration target user E) at the opposing position of the display device 1 in correspondence with a display state of BLOCK 16 in FIG. 3 (=face of BLOCK 26 in FIG. 3) to acquire image data. Furthermore, the recognition/control unit 2 extracts face image data from the acquired image data, and extracts face image feature data from the face image data.

With the aforementioned processes, the personal image data acquisition apparatus can extract the plurality of face image data (face image feature data) corresponding to the plurality of display states, and can register the plurality of face image data (face image feature data) corresponding to the plurality of display states in the storage unit 3.

After that, in response to execution of the recognition mode, the image sensor 4 captures an image of a person (recognition target user R or another user) at the opposing position of the display device 1, and outputs image data. For example, the image sensor 4 captures an image of the person (recognition target user R or another user) irradiated with an illumination in a room or natural light, and outputs image data. The recognition/control unit 2 extracts face image data from the image data, and also extracts face image feature data from the face image data. Furthermore, the recognition/control unit 2 compares a plurality of face image data (face image feature data) registered in the storage unit 3 with the face image data (face image feature data) extracted in response to execution of the recognition mode, and recognizes the recognition target user R based on the comparison result.

For example, the recognition/control unit 2 recognizes the recognition target user R when similarities between one or more face image data (face image feature data) of a plurality of face image data (face image feature data) registered in the storage unit 3 and the face image data (face image feature data) extracted in response to execution of the recognition mode exceed a reference value. That is, the recognition/control unit 2 determines that the recognition target user R is the registered person.

Note that the personal image data acquisition apparatus may acquire a plurality of face image data (face image feature data) at the execution timing of the recognition mode as in the execution timing of the registration mode. In this case, for example, the recognition/control unit 2 compares a plurality of face image data (face image feature data) registered in the storage unit 3 with a plurality of face image data (face image feature data) acquired in response to execution of the recognition mode, and recognizes the recognition target user R based on the comparison result.

For example, the recognition/control unit 2 recognizes the recognition target user R when similarities between one or more face image data (face image feature data) of a plurality of face image data (face image feature data) registered in the storage unit 3 and one or more face image data (face image feature data) of a plurality of face image data (face image feature data) extracted in response to execution of the recognition mode exceed a reference value. That is, the recognition/control unit 2 determines that the recognition target user R is the registered person.

As described above, according to the first embodiment, at the execution timing of the registration mode, the personal image data acquisition apparatus controls to change the light-emitting state on the display device 1 (for example, to change a light-emitting area to a screen center (full screen), upper left position, upper position, upper right position, lower right position, lower left position, etc.), and acquires face images in correspondence with the respective light-emitting states. Thus, the personal image data acquisition apparatus can acquire a plurality of face image data (face image feature data) corresponding to various conditional changes (various environmental changes). As a result, the plurality of acquired face image data (face image feature data) are more likely to include face image data (face image feature data) which is acquired under conditions closer to those at the execution timing of the recognition mode, and a recognition precision drop can be prevented.

### Second Embodiment

In the description of the second embodiment, differences from the first embodiment will be mainly explained, and a description of parts common to the first embodiment will not be repeated.

In response to execution of the registration mode, the recognition/control unit 2 controls display based on a plurality of display control settings stored in the storage unit 3. The display device 1 changes to a plurality of display states based on the display control.

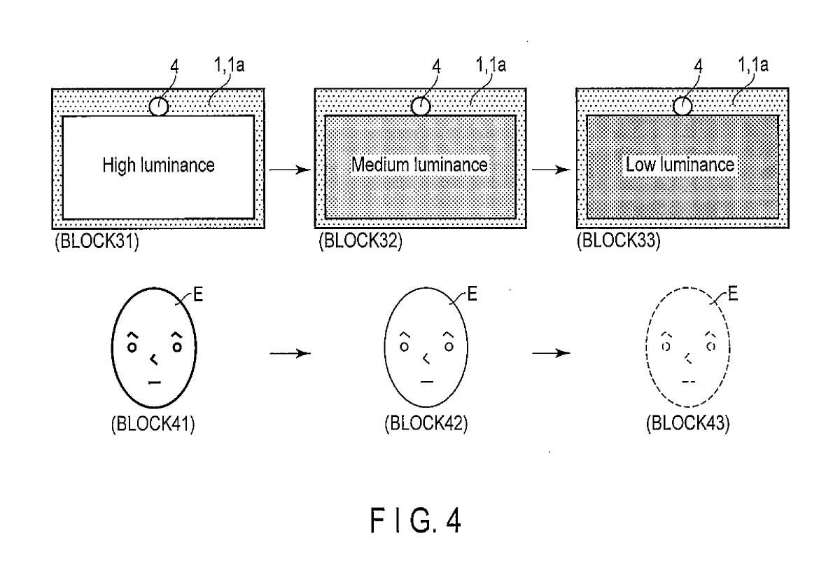

For example, the recognition/control unit 2 controls a light-emitting intensity of the light-emitting device 1a based on a plurality of light-emitting intensity control settings stored in the storage unit 3. The light-emitting device 1a changes to a plurality of light-emitting states based on the light-emitting intensity control, and the display device 1 changes to a plurality of display states in correspondence with the changes of the light-emitting states ([BLOCK 31] to [BLOCK 33] in FIG. 4).

Since irradiated states of light with a person (registration target user E) at an opposing position of the display device 1 change in correspondence with the changes of the plurality of display states ([BLOCK 31] to [BLOCK 33] in FIG. 4), shadow making states and light reflected states on the person (face) change ([BLOCK 41] to [BLOCK 43] in FIG. 4).

The image sensor 4 acquires a plurality of face image data (face image feature data) in correspondence with the plurality of display states. That is, the image sensor 4 captures an image of a person (registration target user E) at the opposing position of the display device 1 in correspondence with a display state of BLOCK 31 in FIG. 4 (=face of BLOCK 41 in FIG. 4) to acquire image data. Furthermore, the recognition/control unit 2 extracts face image data from the acquired image data, and further extracts face image feature data from the face image data.

Likewise, the image sensor 4 captures an image of the person (registration target user E) at the opposing position of the display device 1 in correspondence with a display state of BLOCK 32 in FIG. 4 (=face of BLOCK 42 in FIG. 4) to acquire image data. Furthermore, the recognition/control unit 2 extracts face image data from the acquired image data, and extracts face image feature data from the face image data. The image sensor 4 captures an image of the person (registration target user E) at the opposing position of the display device 1 in correspondence with a display state of BLOCK 33 in FIG. 4 (=face of BLOCK 43 in FIG. 4) to acquire image data. Furthermore, the recognition/control unit 2 extracts face image data from the acquired image data, and extracts face image feature data from the face image data.

With the aforementioned processes, the personal image data acquisition apparatus can extract the plurality of face image data (face image feature data) corresponding to the plurality of display states, and can register the plurality of face image data (face image feature data) corresponding to the plurality of display states in the storage unit 3.

After that, the operation of the personal image data acquisition apparatus in response to execution of the recognition mode is as has been described in the first embodiment, and a detailed description thereof will not be repeated.

As described above, according to the second embodiment, at the execution timing of the registration mode, the personal image data acquisition apparatus controls to change the light-emitting intensity on the display device 1 (for example, to change the light-emitting intensity to “strong” [high luminance (bright)], “medium” [medium luminance (normal)], and “weak” [low luminance (dark)]), and acquires face images in correspondence with the respective light-emitting intensities. Thus, the personal image data acquisition apparatus can acquire a plurality of face image data (face image feature data) corresponding to various conditional changes (various environmental changes). As a result, the plurality of acquired face image data (face image feature data) are more likely to include face image data (face image feature data) which is acquired under conditions closer to those at the execution timing of the recognition mode, and a recognition precision drop can be prevented.

### Third Embodiment

In the description of the third embodiment, differences from the first and second embodiments will be mainly explained, and a description of parts common to the first and second embodiments will not be repeated.

In response to execution of the registration mode, the recognition/control unit 2 controls display based on a plurality of display control settings stored in the storage unit 3. The display device 1 changes to a plurality of display states based on the display control.

For example, the recognition/control unit 2 controls a display color of the display device 1 based on a plurality of display color control settings stored in the storage unit 3. The display device 1 changes to a plurality of display states based on the display color control.

Since irradiated states of light with a person (registration target user E) at an opposing position of the display device 1 change in correspondence with the changes of the plurality of display states, shadow making states and light reflected states on the person (face) change.

The image sensor 4 acquires a plurality of face image data (face image feature data) in correspondence with the plurality of display states. That is, the image sensor 4 captures an image of a person (registration target user E) at the opposing position of the display device 1 in correspondence with a first display state of the display device 1 to acquire image data. Furthermore, the recognition/control unit 2 extracts face image data from the acquired image data, and further extracts face image feature data from the face image data.

Likewise, the image sensor 4 captures an image of the person (registration target user E) at the opposing position of the display device 1 in correspondence with a second display state of the display device 1 to acquire image data. Furthermore, the recognition/control unit 2 extracts face image data from the acquired image data, and extracts face image feature data from the face image data. The image sensor 4 captures an image of the person (registration target user E) at the opposing position of the display device 1 in correspondence with a third display state of the display device 1 to acquire image data. Furthermore, the recognition/control unit 2 extracts face image data from the acquired image data, and extracts face image feature data from the face image data.

With the aforementioned processes, the personal image data acquisition apparatus can extract the plurality of face image data (face image feature data) corresponding to the plurality of display states, and can register the plurality of face image data (face image feature data) corresponding to the plurality of display states in the storage unit 3.

After that, the operation of the personal image data acquisition apparatus in response to execution of the recognition mode is as has been described in the first embodiment, and a detailed description thereof will not be repeated.

As described above, according to the third embodiment, at the execution timing of the registration mode, the personal image data acquisition apparatus controls to change the display color of the display device 1 (for example, to change the display color to “cool daylight”, “sunlight”, and “warm white”), and acquires face images in correspondence with the respective display colors. Thus, the personal image data acquisition apparatus can acquire a plurality of face image data (face image feature data) corresponding to various conditional changes (various environmental changes). As a result, the plurality of acquired face image data (face image feature data) are more likely to include face image data (face image feature data) which is acquired under conditions closer to those at the execution timing of the recognition mode, and a recognition precision drop can be prevented.

Note that two or more embodiments of the aforementioned first, second, and third embodiments can be combined. In this manner, the personal image data acquisition apparatus can acquire a plurality of face image data (face image feature data) under various conditions corresponding to a combination of two or more types of control of the display area control, light-emitting intensity control, and display color control. As a result, the plurality of acquired face image data (face image feature data) are more likely to include face image data (face image feature data) which is acquired under conditions closer to those at the execution timing of the recognition mode, and a recognition precision drop can be prevented.

### Fourth Embodiment

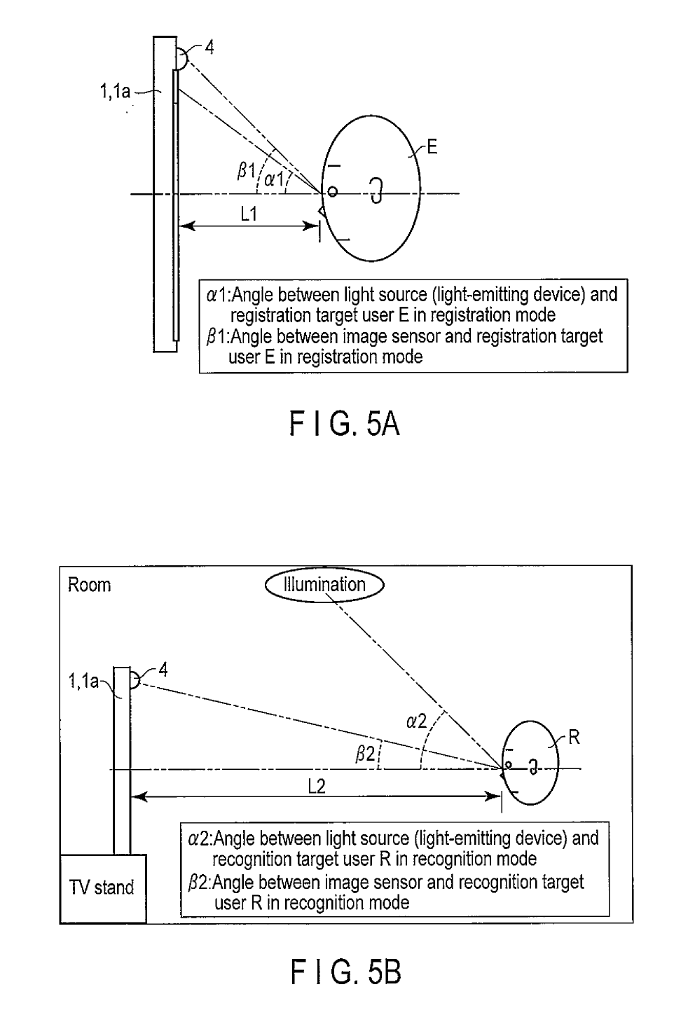

For example, at the execution timing of the registration mode based on the first, second, and third embodiments, it is expected that the positional relationship between an illumination and face in the registration mode (α1 in FIG. 5A) has a smaller difference than that that in the recognition mode (α2 in FIG. 5B) depending on the screen size of the display apparatus 1. Hence, by decreasing a distance from the display device 1 to a person (registration target user E) in the registration mode, an image of the person (registration target user E) at the opposing position of the display device 1 is captured.

For example, the display device 1 displays a guidance that prompts the registration target user E to get closer to the display device 1 in the registration mode. Furthermore, the recognition/control unit 2 may analyze image data acquired by the image sensor 4 to estimate a distance between the registration target user E and display device 1, and may control the contents of the guidance to be displayed by the display device 1. For example, when a distance between the registration target user E and display device 1 is large, the recognition/control unit 2 controls to display a guidance that prompts the user to get closer to the display device 1. When a distance between the registration target user E and display device 1 is too small, the recognition/control unit 2 controls to display a guidance that prompts the user to back away (move backward).

With the aforementioned processing, the personal image data acquisition apparatus can control a distance between the registration target user E and display device 1 to an optimal distance. For example, the personal image data acquisition apparatus can capture an image of the registration target user E by setting a distance between the registration target user E and display device 1 in the registration mode to be smaller than that between the registration target user E and display device 1 in the recognition mode. Thus, a difference between the registration mode (α1 in FIG. 5A) and recognition mode (α2 in FIG. 5B) can be reduced.

### Fifth Embodiment

According to the fourth embodiment, a difference between the registration mode (α1 in FIG. 5A) and recognition mode (α2 in FIG. 5B) can be reduced. On the other hand, when the distance between the registration target user E and display device 1 is decreased, that between the registration target user E and image sensor 4 is consequently decreased. This is because the image sensor 4 is arranged at an upper or lower portion of the display device 1.

The fact that the distance between the registration target user E and display device 1 in the registration mode is smaller than that between the registration target user E and display device 1 in the recognition mode means that an angle (β1 in FIG. 5A) between the image sensor 4 and registration target user E in the registration mode is different from that (β2 in FIG. 5B) between the image sensor 4 and registration target user E in the recognition mode.

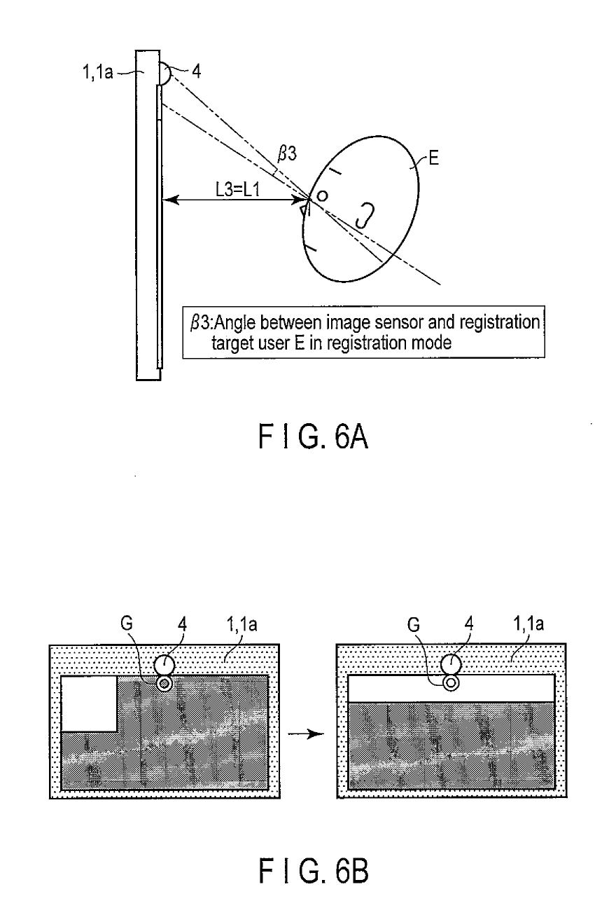

Thus, the display device 1 displays guide information G required to guide a direction of the face of the recognition target user to the image sensor 4. For example, the display device 1 displays a red circle used to guide the visual axis of the registration target user E to a direction of the image sensor 4. For example, as shown in FIG. 6B, the display device 1 displays the guide information G (red circle) at the center of the screen to gradually move the guide information G in the direction of the image sensor 4.

With the above processing, the personal image data acquisition apparatus can guide the face of the registration target user to the image sensor 4, thereby reducing a difference between the angle (β3 in FIG. 6A) between the image sensor 4 and registration target user E in the registration mode and that (β2 in FIG. 5B) between the image sensor 4 and registration target user E in the recognition mode.

### Sixth Embodiment

According to the fourth embodiment, a difference between the registration mode (α1 in FIG. 5A) and the recognition mode (α2 in FIG. 5B) can be reduced. On the other hand, when the distance between the registration target user E and display device 1 is reduced in the recognition mode, that between the registration target user E and image sensor 4 is also consequently reduced. This is because the image sensor 4 is arranged on an upper or lower portion of the display device 1.

The fact that the distance between the registration target user E and display device 1 in the registration mode becomes smaller than that between the registration target user E and display device 1 in the recognition mode means that the angle (β1 in FIG. 5A) between the image sensor 4 and registration target user E in the registration mode is different from that (β2 in FIG. 5B) between the image sensor 4 and registration target user E in the recognition mode.

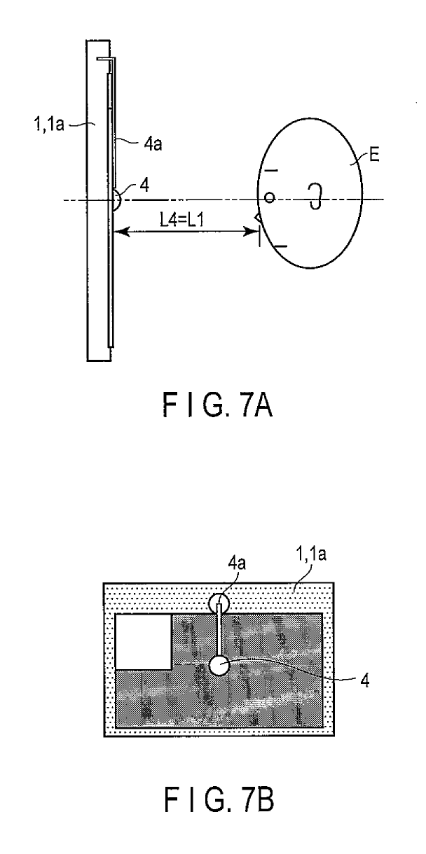

Hence, as shown in FIG. 7B, the image sensor 4 is connected to the personal image data acquisition apparatus via a signal cable 4a, thus allowing the image sensor 4 to be movable. For example, as shown in FIG. 7A, the image sensor 4 is moved to a position near the center of the display device 1 in the registration mode to capture an image of the registration target user E. For example, in the registration mode, the display device 1 displays guidance messages about movement of the image sensor 4 and the location of the image sensor 4 in the registration mode.

With the aforementioned processing, the personal image data acquisition apparatus can reduce a difference between the angle between the image sensor 4 and registration target user E in the registration mode and that between the image sensor 4 and registration target user E in the recognition mode.

The first to sixth embodiments will be summarized below.

(1) The personal image data acquisition apparatus includes a display device larger than a face, and controls the display device to locally emit light in white, a natural color, or a color (color temperature) close to an illumination and to change a light-emitting position to a plurality of positions, thus acquiring a plurality of face images in correspondence with the plurality of changes in light-emitting position. Thus, a plurality of image data corresponding to various conditions can be registered as those for one person.

(2) The personal image data acquisition apparatus includes a display device larger than a face, and controls the display device to locally emit light in white, a natural color, or a color (color temperature) close to an illumination and to change a light-emitting intensity to a plurality of levels, thus acquiring a plurality of face images in correspondence with the plurality of changes in light-emitting intensity. Thus, a plurality of image data corresponding to various conditions can be registered as those for one person.

(3) The personal image data acquisition apparatus executes a capturing operation in the user registration mode at a distance smaller than a capturing distance in the user recognition mode.

(4) The personal image data acquisition apparatus displays guide information required to guide the direction of the face of the recognition target user toward the image sensor 4 in the user registration mode.

(5) The personal image data acquisition apparatus captures an image of the recognition target user R by the image sensor arranged near the center of the screen of the display device in the user registration mode.

As described above, the personal image data acquisition apparatus can acquire face image data (face image feature data) under various environmental conditions without imposing a heavy load on the registration target user, thus improving person identification precision. The personal image data acquisition apparatus can obtain the above effects without increasing any cost of the apparatus.

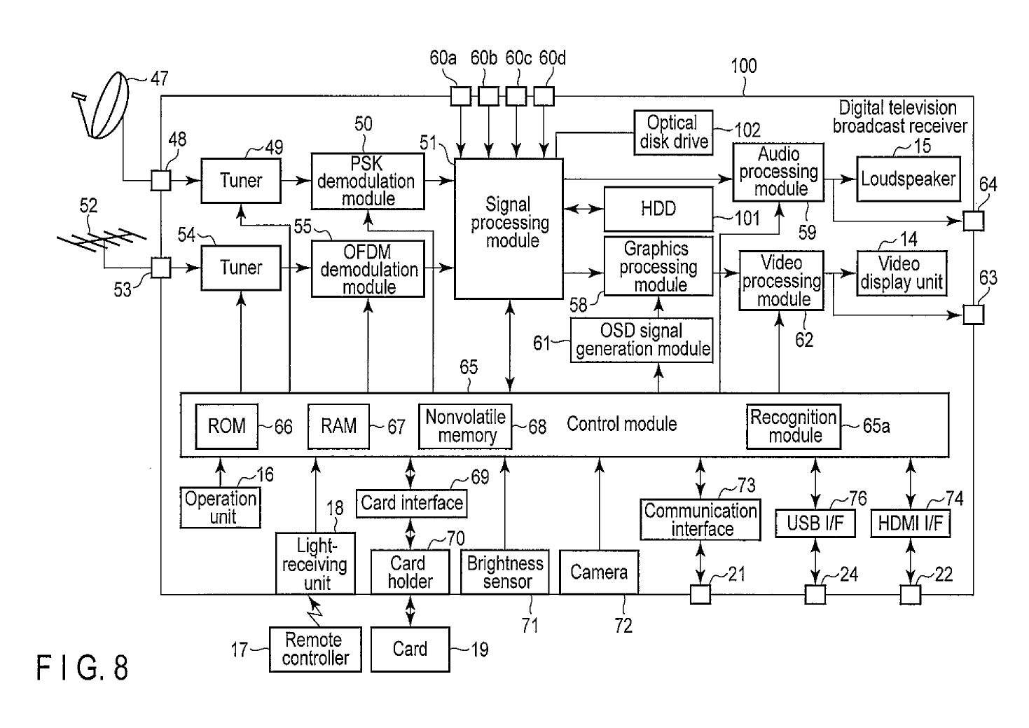

FIG. 8 is schematic block diagram showing the arrangement of a digital television broadcast receiver to which the personal image data acquisition apparatus is applied. A video display unit 14 of the digital television broadcast receiver corresponds to the display device 1 shown in FIG. 1. Also, a control module 65 and recognition module 65a of the digital television broadcast receiver correspond to the recognition/control unit 2 shown in FIG. 1. Furthermore, a nonvolatile memory 68 of the digital television broadcast receiver corresponds to the storage unit 3 shown in FIG. 1. Moreover, a camera 72 of the digital television broadcast receiver corresponds to the image sensor 4 shown in FIG. 1.

The digital television broadcast receiver will be briefly described below.

As shown in FIG. 8, a satellite digital television broadcast signal, which is received by a DBS digital broadcast receiving antenna 47, is supplied to a satellite digital broadcast tuner 49 via an input terminal 48, and the tuner 49 tunes a broadcast signal of a designated channel.

The broadcast signal tuned by this tuner 49 is supplied to a phase-shift keying (PSK) demodulation module 50, and is demodulated to obtain a digital video signal and audio signal, which are then output to a signal processing module 51.

A terrestrial digital television broadcast signal, which is received by a terrestrial broadcast receiving antenna 52, is supplied to a terrestrial digital broadcast tuner 54 via an input terminal 53, and the tuner 54 tunes a broadcast signal of a designated channel.

The broadcast signal tuned by this tuner 54 is supplied to an orthogonal frequency division multiplexing (OFDM) demodulation module 55, and is demodulated to obtain a digital video signal and audio signal, which are then output to the signal processing module 51.

The signal processing module 51 selectively applies predetermined digital signal processing to the digital video and audio signals respectively supplied from the PSK demodulation module 50 and OFDM demodulation module 55, and outputs the processed signals to a graphics processing module 58 and audio processing module 59.

To the signal processing module 51, a plurality of (four in FIG. 8) input terminals 60a, 60b, 60c, and 60d are connected. These input terminals 60a to 60d allow to respectively input analog video and audio signals from a device outside the digital television broadcast receiver 100.

The signal processing module 51 selectively converts the analog video and audio signals respectively supplied from the input terminals 60a to 60d into digital video and audio signals, applies predetermined digital signal processing to the digital video and audio signals, and then outputs these signals to the graphics processing module 58 and audio processing module 59.

Of these processing modules, the graphics processing module 58 has a function of superimposing an on-screen display (OSD) signal generated by an OSD signal generation module 61 on the digital video signal supplied from the signal processing module 51, and outputting that signal. This graphics processing module 58 can selectively output the output video signal of the signal processing module 51 and the output OSD signal of the OSD signal generation module 61, or can combine and output these outputs.

The digital video signal output from the graphics processing module 58 is supplied to a video processing module 62. The video signal processed by the video processing module 62 is supplied to the video display unit 14, and also to an output terminal 63. The video display unit 14 displays an image based on the video signal. When an external device is connected to the output terminal 63, the video signal supplied to the output terminal 63 is input to the external device.

The audio processing module 59 converts the input digital audio signal into an analog audio signal which can be played back by a loudspeakers 15, and outputs the analog audio signal to the loudspeakers 15 to output a sound and also externally outputs it via an output terminal 64.

Note that the control module 65 of the digital television broadcast receiver 100 integrally controls all processes and operations including the aforementioned signal processes and the like. Also, the control module 65 controls execution of the aforementioned registration mode or recognition mode, and the recognition module 65a executes the registration processing and recognition processing.

The control module 65 includes a central processing unit (CPU) and the like. The control module 65 controls respective modules based on operation information from an operation unit 16, that which is output from a remote controller 17 and is received by a light-receiving unit 18, or that which is output from a communication module 203 of a mobile phone 200 and is received via the light-receiving unit 18, so as to reflect the operation contents.

In this case, the control module 65 mainly uses a read-only memory (ROM) 66 which stores control programs executed by the CPU, a random access memory (RAM) 67 which provides a work area to the CPU, and the nonvolatile memory 68 which stores various kinds of setting information, control information, and the like.

This control module 65 is connected to a card holder 70, which can receive a memory card 19, via a card interface 69. Thus, the control module 65 can exchange information with the memory card 19 attached to the card holder 70 via the card interface 69.

Also, the control module 65 is connected to a LAN terminal 21 via a communication interface 73. Thus, the control module 65 can exchange information via a LAN cable connected to the LAN terminal 21 and the communication interface 73. For example, the control module 65 can receive data transmitted from a server via the LAN cable and communication interface 73.

Furthermore, the control module 65 is connected to an HDMI terminal 22 via an HDMI interface 74. Thus, the control module 65 can exchange information with HDMI-compatible devices connected to the HDMI terminal 22 via the HDMI interface 74.

Moreover, the control module 65 is connected to a USB terminal 24 via a USB interface 76. Thus, the control module 65 can exchange information with USB-compatible devices (such as a digital camera and digital video camera) connected to the USB terminal 24 via the USB interface 76.

In addition, the control module 65 refers to video recording reservation information included in a video recording reservation list stored in the nonvolatile memory 68, and controls a video recording operation of a program based on a reception signal. As a video recording destination, for example, a built-in HDD 101, an external HDD connected via the USB terminal 24, and a recorder connected via the HDMI terminal are available.

Also, the control module 65 controls the brightness of a backlight of the video display unit 14 based on a brightness detection level from a brightness sensor 71. The control module 65 controls ON/OFF of an image on the video display unit 14 by determining the presence/absence of a user at an opposing position of the video display unit 14 based on moving image information from the camera 72.

The control module 65 includes a program guide output control module 103. The program guide output control module 103 controls a program guide to be output.

According to at least one embodiment, a personal image data acquisition apparatus and personal image data acquisition method, which can prevent a recognition precision drop without imposing any load on the user (registration user) can be provided.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A display apparatus comprising:
a display controller configured to control display based on a plurality of display control settings;
a display configured to change to a plurality of display states based on the display control; and
an acquisition module configured to acquire a plurality of personal image data in correspondence with the plurality of display states; and
an input module configured to input an image signal;
wherein the display comprises a backlight,
the display controller is configured to control light-emitting of a plurality of light-emitting areas included in the backlight based on a plurality of light-emitting area control settings,
the display is configured to change to the plurality of display states in correspondence with the light-emitting control of the plurality of the light-emitting areas included in the backlight by the display controller, and the acquisition module is configured to acquire the plurality of personal image data in correspondence with the plurality of display states, and
the display is configured to change to the plurality of display states in correspondence with the light-emitting control of the plurality of light-emitting areas included in the backlight by the display controller, and to display an image based on the image signal.

2-3. (canceled)

4. The apparatus of claim 1, wherein the display controller is configured to control a light-emitting intensity of the backlight based on a plurality of light-emitting intensity control settings, and
the display is configured to change to the plurality of display states in correspondence with changes of a plurality of light-emitting states based on the light-emitting intensity control.

5. The apparatus of claim 1, wherein the display controller is configured to control a display color based on a plurality of color control settings, and
the display is configured to change to the plurality of display states based on the display color control.

6. The apparatus of claim 1, wherein the acquisition module comprises an image sensor configured to capture an image of a recognition target user, and is configured to acquire the plurality of personal image data in correspondence with a plurality of capturing operations by the image sensor.

7. The apparatus of claim 6, wherein the display is configured to display guide information required to guide a direction of a face of a recognition target user to an image sensor.

8. The apparatus of claim 1, further comprising a registration module configured to register the plurality of personal image data as data of one person.

9. (canceled)

10. The apparatus of claim 1, wherein the input module is configured to input a broadcast signal including the image signal.

11. The apparatus of claim 1, comprising:
a brightness sensor,
wherein the display controller is configured to control brightness of the backlight based on a brightness detection level from the brightness sensor.

12. A display control method comprising:
a display controller controls light-emitting of a plurality of light-emitting areas included in a backlight of a display based on a plurality of light-emitting area control settings,
the display changes to a plurality of display states in correspondence with the light-emitting control of the plurality of light-emitting areas included in the backlight by the display controller, and a camera acquires a plurality of personal image data in correspondence with the plurality of display states, and
a input module inputs a image signal, the display changes to the plurality of display states in correspondence with the light-emitting control of the plurality of light-emitting areas included in the backlight by the display controller, and displays an image based on the image signal.
